(19) United States
(12) Patent Application Publication
(10) Pub. No.: US 2009/0312497 A1
(43) Pub. Date: Dec. 17, 2009

(54) GEL SHEET FOR PROTECTING SKIN

(76) Inventors: Takehiko Oura, Hokkaido (JP); Kazuo Yuzurihara, Kanagawa (JP)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/913,867

(22) PCT Filed: May 2, 2006
(86) PCT No.: PCT/JP2006/309148

§ 371 Date: Nov. 8, 2007

(30) Foreign Application Priority Data
May 11, 2005 (JP) 2005-138748

(51) Int. Cl. C08L 23/08

(52) U.S. Cl. 525/240

(57) ABSTRACT

It is intended to provide a very inexpensive and heavy-duty gel sheet for protecting the skin to be used for the prevention of pressure ulcer caused by skin therapy and congestion or the like not by applying it to a wounded region or cut but by applying it to a region of pressure ulcer, keloid, hypertrophic scar or the like caused by congestion or the like. It was expected that even though its composition was not silicone, if it was a substance having properties similar to those of silicone, i.e. a moisturizing property, pressure exerted by adhesion and the like, a gel sheet for protecting the skin which is less expensive and more heavy-duty than a conventional silicone gel sheet could be produced. As a result of intensive studies, a gel sheet for protecting the skin which is less expensive and more heavy-duty than a conventional silicone gel sheet was successfully produced. Here, the gel sheet for protecting the skin is produced by copolymerizing polyethylene and polystyrene.

### TECHNICAL FIELD

The present invention relates to a gel sheet for protecting skin that is used for treating skin disorders such as pressure ulcer, keloid, or hypertrophic scar or for preventing pressure ulcer caused by congestion or the like.

### BACKGROUND ART

Conventionally, a silicone gel sheet has been used for treating skin disorders such as pressure ulcer, keloid, or hypertrophic scar.

The mechanism is not clarified yet why the silicone gel sheet has an advantageous effect on treatment of skin disorders such as pressure ulcer, keloid, and hypertrophic scar caused by congestion or the like. However, it is thought and inferred that the silicone gel sheet prevents moisture supply and moisture evaporation from the skin and, at the same time, does not change an oxygen partial pressure because of its semipermeability, presses the skin by adhesion, and, for mast cells increasing in keloid, reduces the number of the mast cells in a collagen product by working on the mast cells by static electricity of several hundreds volts flowing in the silicone and the silicone gel sheet at every inch.

In addition to the silicone gel sheet, a wound-protecting dressing is known (refer to Patent Document 1, for example). The dressing includes a base material made of a plastic film, a hydrophobic adhesive that is disposed on one face of the base material and contains an elastic polymer as a main component, a hydrophilic adhesive disposed on this hydrophobic adhesive, and a release paper attached on this hydrophilic adhesive so as to cover the adhesive face.

However, it is often pointed out that the silicone gel sheet is too expensive to be used for actual medical care, in particular, in elder care facilities or the like and therefore cannot be employed because of its high price.

In addition, it is pointed out that the silicone gel sheet has properties that it is fragile and readily broken.

Furthermore, the wound-protecting dressing is applied to an injury area, i.e., to a wound, but is not used for treating a skin disorder by applying (attaching) it to pressure ulcer, keloid, hypertrophic scar, or the like caused by congestion or the like and is not used for preventing pressure ulcer caused by congestion or the like.

Accordingly, Harasawa Pharmaceutical Co., Ltd., which is one of the present applicants, has developed a relatively low priced “silicone gel sheet” (refer to Non-Patent Document 1, for example).

Patent Document 1: Japanese Patent Application Laid-Open No. 2003-339762 (paragraph [0006]).

Non-Patent Document 1: Ogawa, R., Akaishi, S., Hyakusoku, H. “Experimental use of silicone gel sheet for “keloid and hypertrophic scar”, the first report”, Rinsho Iyaku (Journal of Clinical Therapeutics & Medicines), April 2004 (Heisei 16), 20(4), Suppl. pp. 459(79)-464(84).

### DISCLOSURE OF INVENTION

The silicone gel sheet developed by Harasawa Pharmaceutical Co., Ltd. is inexpensive compared to conventional products, but is still relatively expensive to be used for actual medical care and in elder care facilities or the like.

Accordingly, it is an object of the present invention to provide a gel sheet for protecting skin that is very inexpensive and durable and that is not applied to an injury area, i.e., a wound but is applied to an area such as pressure ulcer, keloid, or hypertrophic scar that is caused by congestion or the like for treating the skin disorder or is used for preventing pressure ulcer caused by congestion or the like.

The present inventors have thought that a gel sheet for protecting skin that is inexpensive compared to the conventional silicone gel sheets and is durable can be produced, without using silicone, by using a material having properties similar to those of silicone, such as moisture-retaining properties and pressure-generating adhesion. As a result of intensive studies, the present inventors have succeeded in producing a gel sheet for protecting skin that is durable and inexpensive compared to conventional silicone gel sheets (about half of the price of the silicone gel sheet of Harasawa Pharmaceutical Co., Ltd.).

The gel sheet for protecting skin according to the present invention includes a copolymer of polyethylene and polystyrene.

The gel sheet for protecting skin according to the present invention is durable and can be washed and used repeatedly. Thus, the sheet can be purchased at a low price and, at the same time, can be further reduced in expense by using it repeatedly.

The gel sheet for protecting skin of the present invention is produced by mixing a plasticizer (paraffin-based process oil), an additive (paraffin-based oil-gelling agent), and a hydrogenated hydrocarbon resin with a copolymer of polyethylene and polystyrene.

Pressure ulcer due to congestion or the like is caused by pressing the skin to, for example, a bed (in particular, hospital bed) or a chair (in particular, wheel chair) for a long time, but the pressure ulcer is not caused by applying the gel sheet for protecting skin of the present invention to such a skin area. Thus, the gel sheet for protecting skin can also prevent occurrence of pressure ulcer. Furthermore, the gel sheet for protecting skin of the present invention is very low in price, durable, and can be used repeatedly by washing it with water. Therefore, by these advantageous characteristics, the sheet can be employed for preventing the occurrence of pressure ulcer.

Since the present invention has the above-described composition, the gel sheet for protecting skin that is very durable and is low in cost can be provided. Therefore, the gel sheet for protecting skin can be widely used not only for actual medical care and in elder care facilities or the like, but also to patients who are required to be treated for, for example, pressure ulcer, keloid, and hypertrophic scar caused by congestion or the like. Furthermore, the sheet can prevent occurrence of pressure ulcer caused by congestion.

### EXAMPLES

Experimental examples of the present invention will now be described.

### Experimental Example 1

### Therapeutic Effects

A two-year and eight-month-old female infant was scalded with boiling water at the breast, and hypertrophic scar grew gradually after the scalding. A gel sheet for protecting skin (6 cm×12 cm×1.5 mm) of the present invention was applied to the scalded area. It was confirmed by the observation over 10 weeks that redness regressed and also telangiectasis disappeared.

### Experimental Example 2

### Therapeutic Effects

A 32-year old female had redness and itching one year after ablation of keloid at the left shoulder. A gel sheet for protecting skin of the present invention was applied to the affected area. It was confirmed by the observation over eight weeks that the itching was relieved and the redness tended to be less severe.

### Experimental Example 3

### Preventive Effects on Pressure Ulcer

Subjects were four males and six females having an average age of 38.7 years (from 1 to 77 years). Operations were performed on the back (two subjects), the shoulder (one subject), the lower abdominal region (one subject), and the leg (six subjects) and took 8 to 15 hours. A gel sheet for protecting skin (25 cm×30 cm×3 mm) of the present invention was applied to each subject at the portion lying down on bed. As a result, the subjects did not suffer from pressure ulcer.

1. A gel sheet for protecting skin comprising a copolymer of polyethylene and polystyrene.
